(19) United States
(12) Patent Application Publication
(10) Pub. No.: US 2004/0133980 A1
(43) Pub. Date: Jul. 15, 2004

(54) Indexing positioning system for accurate and repetitive positioning of patients in a multimodal environment

(76) Inventors: Daniel D. Coppens, Avondale, PA (US); David M. Rabeno, Bear, DE (US); Gray Gearon, Shohola, PA (US); John Damon Kirk, Ramsey, NJ (US)

Correspondence Address: HUNTLEY & ASSOCIATES, 1105 NORTH MARKET STREET, P.O. BOX 948, WILMINGTON, DE, 19899-0948, US

(21) Appl. No.: 10/633,231

(22) Filed: Aug. 2, 2003

Related U.S. Application Data
(60) Provisional application No. 60/440,126, filed on Jan. 15, 2003.
(60) Provisional application No. 60/446,920, filed on Feb. 12, 2003.

(51) Int. Cl. A61G 13/00

(52) U.S. Cl. 5/601

(57) ABSTRACT

A patient support device for accurately and repeatably positioning a patient for treatment. The device comprises a top surface, a bottom surface, two sides and at least two sidewalls. The device can include an integral indexing means and an accessory device adaptor for receiving various accessories. The device can incorporate chamfered edge technology and can include indexing grooves on at least one surface of the device.

### CROSS-REFERENCE TO RELATED APPLICATIONS

This application claims the benefit of U.S. Provisional Application No. 60/440,126, filed Jan. 15, 2003 and U.S. Provisional Application No. 60/446,920, filed Feb. 12, 2003.

### BACKGROUND OF THE INVENTION

In state of the art cancer therapy, it is essential to be able to perform diagnostic imaging of a patient in a manner that the specific coordinates of cancerous tissue and other body structures can be obtained. This information is then used to plan the path of the treatment beam. Since the patient may require diagnostic imaging through multiple methods or modes (such as CT, MRI, PET, Therapy Simulation) and the patient will likely undergo several treatment sessions over many months, accurate and repeatable positioning is required to ensure the treatment beam is placed accurately on the tumor each time. For example, the precise location and form of a tumor may be acquired by placing the patient in a CT machine. To gain greater clarification, the patient may be moved to an MRI machine for additional diagnostic scanning. Once the location and form of the tumor had been identified, the patient may be moved to a Radiation Therapy Simulator on which the exact path of the treatment beam may be planned prior to actual irradiation of the tumor. Then the patient may be moved to a Linear Accelerator for actual treatment. This treatment may be repeated on several different sessions over a series of days, weeks or months. It is tremendously important to have a positioning system which allows the patient to be accurately and repeatably positioned with respect to a known coordinate system.

Current indexing immobilization systems have several drawbacks in that they do a poor job of eliminating patient motion in all six degrees of freedom (particularly in the vertical translation degree of freedom), and do not lend themselves to optimal application in multiple diagnostic imaging and treatment modes. Some currently available systems, such as described in U.S. Pat. No. 6,161,237 to Tang et al., attempts to limit patient motion by providing a patient positioning device with pairs of indexing notches on opposite sides of the device. However, this design does not sufficiently restrict patient movement. Furthermore, producing the systems with pairs of opposing notches along the sides of the table increases the level of error because it is difficult to precisely align the notches. Small variations in placement of the notching can cause unacceptable spacing that can translate into imprecise and inconsistent attachment of positioning devices, which in turn increases the likelihood of patient movement.

Current patient tables for Radiation Therapy (RT) often incorporate a feature that allows the patient to be indexed with respect to the treatment beam such that the tumor can be repeatably irradiated. However, these tables have straight sidewalls and the incorporation of the indexing feature is accomplished with semi-circles cut into a solid hard edge running down the edge of the table. This set up may be acceptable in Radiation Therapy treatment but only if the gantry is positioned anywhere above the patient, or approximately within a 90 degree window below the patient. The diagnostic imaging procedures are further constrained in that imaging is only sufficient within approximately 90 degree windows above and below the patient and in approximately 45 degree windows on either side of the patient (see FIGS. 1A and 1B). These limitations are the result of the edges of the table presenting very high absorption of KeV and MeV range radiation. With modern techniques such as Intensity Modulated Radiation Therapy (IMRT), and Stereotactic Imaging used in RT, this high level of absorption presents a problem because the absorptive edge blocks the desired radiation path at oblique angles.

The present invention overcomes the above described deficiencies and provides a durable patient support and immobilization device, that allows precise, efficient and repeatable adjustability of a patient with improved radiation translucency at all treatment angles.

### SUMMARY OF THE INVENTION

It is, therefore, an object of the present invention to provide an improved patient support device for easy, accurate and repeatable positioning of a patient for treatment. Another objective is to provide an accessory device adaptor that can repeatably and precisely attach to the patient support device that is capable of receiving various accessory devices. Another objective of the present invention is to provide a patient support device with chamfered edge technology for increased radio translucency at all treatment angles.

Specifically, the present invention provides a patient support device comprising a top surface, a bottom surface, two sides and at least two sidewalls; wherein the first side contains an integral indexing means and the second side is free of indexing means; and wherein the integral indexing means comprises at least one positioning feature. The two sides are defined as the area to the left and right of the centerline of the device. This area is distinguished from the sidewalls because indexing features can be incorporated on one or both sides of the device yet may not affect the sidewalls. The reverse is also contemplated in that the indexing features can be incorporated into one or more of the sidewalls of the device.

The present invention describes an indexed patient support device and multiple methods for attaching patient positioning and immobilization devices to the device. Placing a series of positioning features, such as notches or holes, down one side of the device with a parallel opposing side, free of positioning features, we created an accurate and repeatable indexing support device. In one embodiment, various accessory devices can be attached directly to the patient support device. In a preferred embodiment, an immobilization accessory device adapter can be attached to the table. In this configuration, various accessory devices can be attached to the device adaptor. Alternatively, an attachment mechanism can be incorporated directly into the device itself.

In another preferred embodiment, the top surface of the patient support device extends laterally beyond at least one sidewall, thereby forming a lip. In this embodiment, positioning features can be contained in the lip on one side of the device, while the opposing side is free of positioning features.

In another preferred embodiment, at least one sidewall can be chamfered with respect to the top surface of the patient support device.

In yet another preferred embodiment, the opposing sides contain positioning features that are asymmetrically spaced from each other.

In still another preferred embodiment, the indexing means can include grooves which can be incorporated into a surface of the patient support device.

### BRIEF DESCRIPTION OF THE DRAWINGS

FIGS. 1A and 1B are illustrations of treatment and imaging angles of prior art RT tables.

FIGS. 2A and 2B are illustrations of treatment and imaging angles of the present invention.

FIG. 3 shows an indexing edge of a prior art Radiation Therapy table.

FIGS. 4A and 4B shows one aspect of the present invention.

FIGS. 5A, 5B, 6A, 6B, 7A-C, 8A-C, 9A-C, 10, 11A and 11B show embodiments of the present invention.

### DETAILED DESCRIPTION OF THE INVENTION

The patient support device of the present invention provides a multi-modal support and immobilization device for accurate and repeatable positioning of a patient for treatment. These objectives are accomplished in several ways including a superior indexing means, the ability to incorporate an accessory device adaptor or directly attach various accessory devices, incorporating an extended lip configuration enabling superior attachment options and incorporating chamfered edge technology for eliminating unfavorable imaging and treatment angles.

The present support device provides increased efficiency and flexibility in that it can be used in various treatment modalities, thereby allowing a single device to be used throughout a patients' individual course of treatment. This allows a more accurate and repeatable treatment device because various accessories devices can be precisely indexed and the patient positioning is accurate and repeatable in any diagnostic machine during several treatments over the course of several months and with various patient positioning accessory devices

In addition to the increased flexibility of the patient support device, the present invention provides superior patient positioning and immobilization. The present invention provides superior patient immobilization while motion in the vertical degree of freedom is completely eliminated by allowing the accessory device or device adaptor to either attach securely to the patient support device edge or grab the underside of the support device lip.

With accessory devices in place, one can accurately and repeatably position patients on the support surface quickly and easily. In addition, the patient can be transferred from one support surface to another support surface, depending on the course of treatment, while maintaining the same positioning coordinate system.

Superior accuracy can be achieved in positioning a patient with the present invention when compared to a system with opposing notches on both sides of a table. This can be accomplished by providing a system with notches down one side only and a straight and parallel edge on the opposite side. In this way, inaccuracy in the tolerance of producing two precisely opposing notches on opposite sides of the support surface can be eliminated. And although we describe the indexing means as a notch, the present invention contemplates any equivalent means that would be readily known by those skilled in the art. These equivalent means include the use, alone or in combination, of a notch, slat, indentation, cutout, scallop, groove, hole protrusion, tab, pin and bar.

In a preferred embodiment, we provide an indexing improvement and have overcome the problem of inaccurate spacing of the opposing notches by implementing asymmetric spacing along at least two sides of the patient support device.

In yet another preferred embodiment, the patient support device of the present invention incorporates indexing grooves on at least one surface of the device. Indexing grooves on at least one surface of the device can be used in lieu of notches. Transverse grooves can also be placed to further aid in positioning and clamping an accessory device adaptor or accessories to the patient device.

Referring to the drawings, it should be understood that that the dimensions may vary from that shown in the drawings and the drawings are presented for illustrative purposes only. The precise shapes and dimensions of the invention can be changed without departing from the object of the present invention. Furthermore, the arrangement and specific design may change without departing from the scope of the invention.

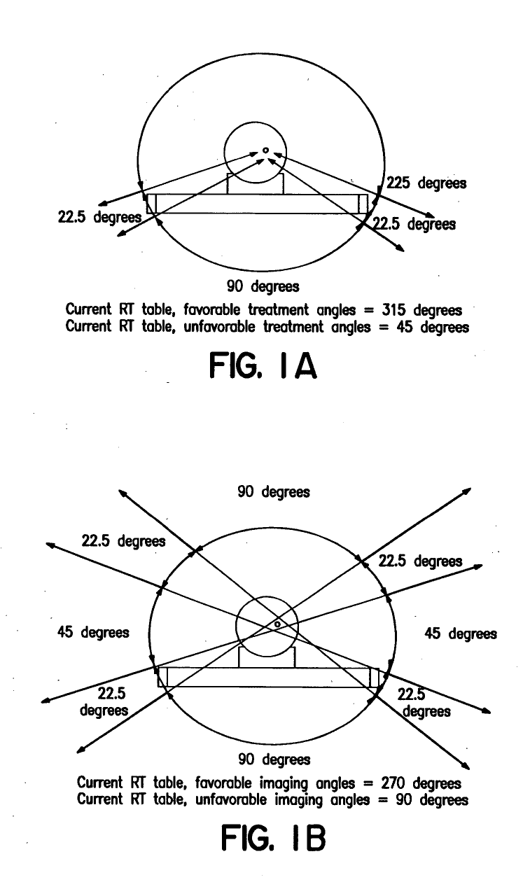

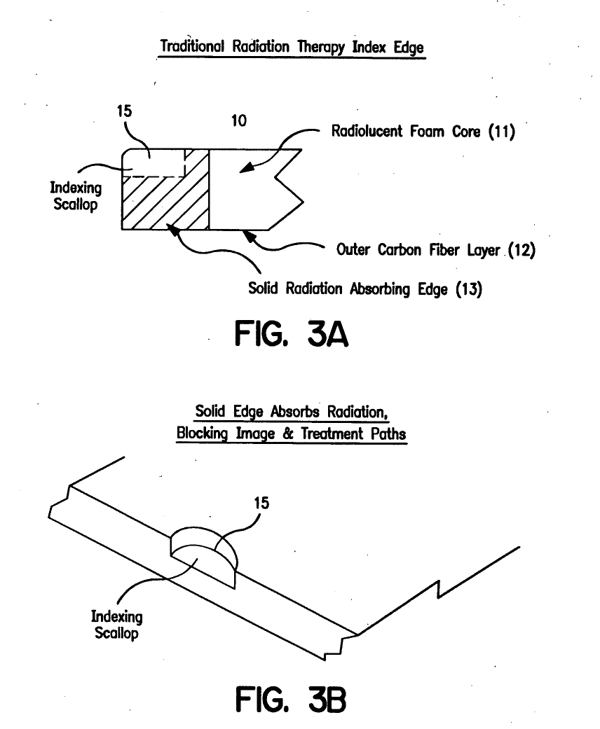

FIG. 3 shows prior art Radiation Therapy table index edge 10. The table is constructed of a radiolucent foam core 11 with an outer carbon fiber layer 12. An indexing scallop 15 is cut into the solid radiation absorbing edge 13. As shown in FIGS. 1A and 1B, the square edge of prior art tables have unfavorable treatment and imaging angles.

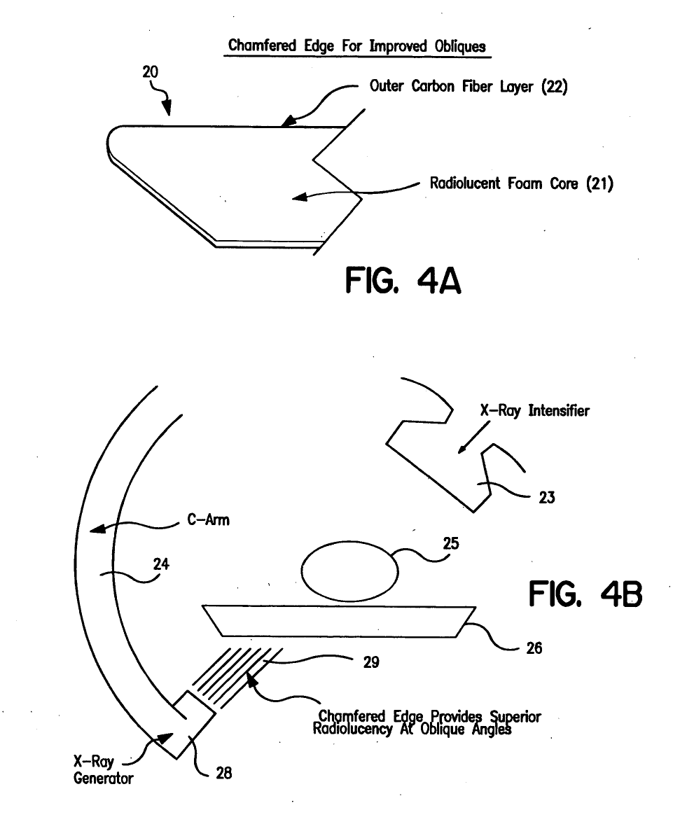

FIG. 4A illustrates the chamfered edge technology of the present invention. The patient support device of the present invention 20 can include a chamfered edge design. The chamfered edge has a radiolucent foam core 21 and an outer carbon fiber layer 22. The patient support device of the present invention 26 is shown in FIG. 4B supporting a patient 25 and in use with a C-arm 24, which incorporates an x-ray generator 28 and an x-ray intensifier 23. As shown, the x-ray beam 29, is directed at the patient 25 and passes through the table 26.

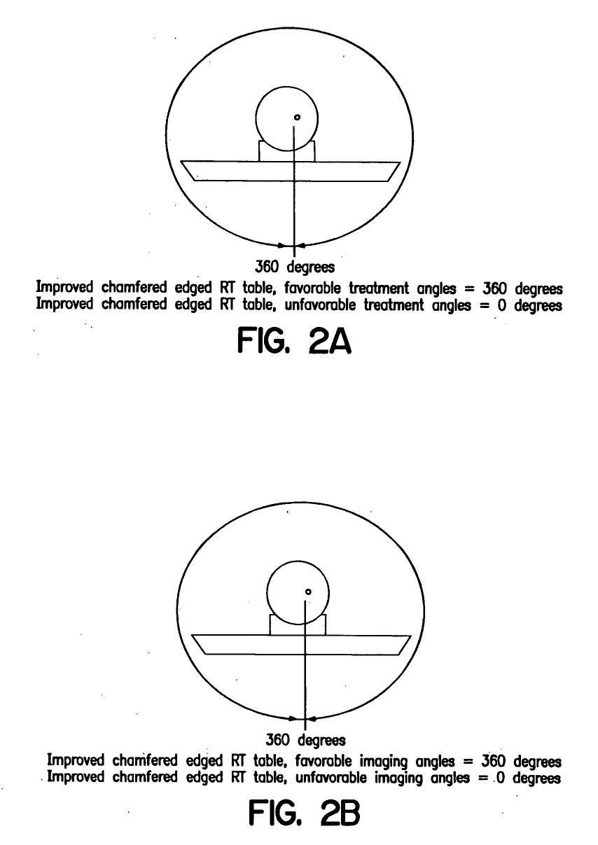

The imaging and treatment angles when using the present invention with the chamfered edge technology, are shown in FIGS. 2A and 2B, and illustrate increased treatment and imaging angles and the elimination of unfavorable angles. By producing a patient table with a trapezoidal cross-section design, we have created a vastly improved patient support device that is much more radiation translucent at all angles and phantom images are kept to minimum.

After the imaging phase and the coordinates of the affected tissue are established, the patient can then proceed through various treatment modalities. One treatment option includes radiation therapy. Radiation therapy sends a high-energy beam into the patient to attack the affected tissue. The level of the energy beam depends upon the location of the affected tissue. A higher energy beam is required to reach deeper into the body. In addition to the location of the affected tissue, the intensity of the energy beam required depends upon what material the beam must travel through, for example, the patient support device. Therefore, in order to direct the high energy beam through a patient support device and into the patient, the patient support must be as radiation translucent as possible. If the device is not sufficiently radiolucent, there will be a shift in the depth of the maximum dosage point which results in a variation in the energy intensity of the beam reaching the affected tissue.

The device of the present invention achieves this objective in part by incorporating the chamfered edge technology. The chamfered edge eliminates unfavorable imaging and treatment angles and provides superior radiolucency at oblique angles. By decreasing radiation blocking and allowing the high energy beam to travel freely through the device, we can keep the shift in the depth of the maximum dosage point to a minimum.

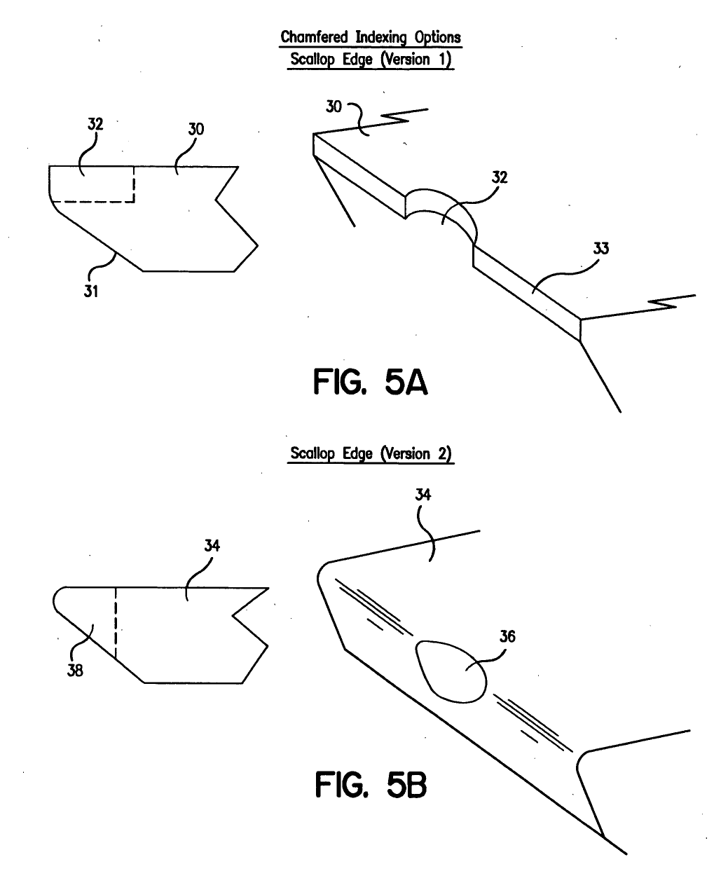

FIGS. 5A and 5B illustrate indexing variations on the patient support device of the present invention. While the following figures show individual variations, it should be understood that any combination of indexing variations can be used depending upon the use of the device and the compatibility of the various accessory devices or the attachment needs of the device adaptor. As one skilled in the art would readily recognize, the incorporation of the indexing means can take several forms. For example, although the present invention describes incorporating the indexing means into at least one side, several variations are contemplated. It should be understood that the indexing means can be located through the top surface of the device and either extend part way or the entire thickness of the support device. Furthermore, the indexing means can extend partially through at least one sidewall or completely through the sidewall.

FIG. 5A illustrates a patient support device 30 with a vertical sidewall portion 33 and a chamfered portion of the sidewall 31. An indexing scallop 32 can be cut out of the vertical portion of the device sidewall 33 and into a portion of the top surface of the device 30. FIG. 5B shows a variation in the scallop edge with a device 34 that has a rounded top sidewall edge 38 and the scallop 36 cut out of a portion of the rounded sidewall edge 38 and a portion of the top surface of the device 34.

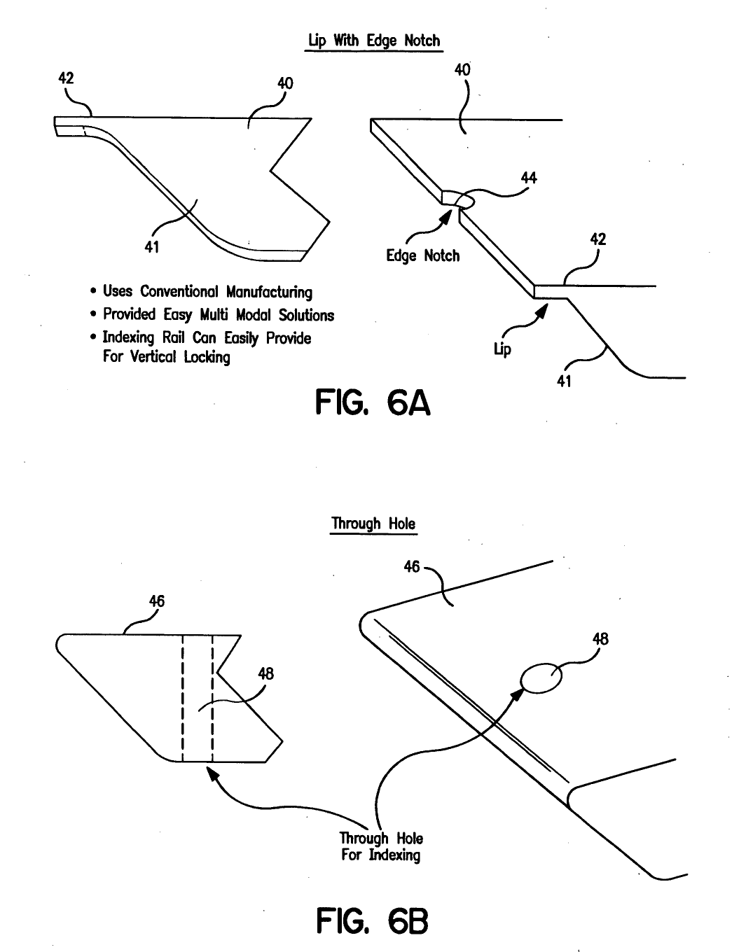

A preferred embodiment of the patient support device of the present invention is shown in FIG. 6A. A support device 40 is shown with a lip 42 extended beyond the chamfered edge 41 of the device 40. In this embodiment, an edge notch 44 is cut out of the lip 42 portion of the device 40. This device can be manufactured using conventional methods and can provide easy multimodal treatment solutions. Furthermore, the indexing lip 42 can provide easy vertical locking with an accessory device or accessory device adaptor, depending on the specific support device requirements.

FIG. 6B illustrates an indexing variation that includes a through hole 48 that can be drilled through the top surface of the patient support device 46. The indexing hole 48 allows simple, accurate and repeatable positioning of the accessory device adaptor or an accessory device. Although not shown, a hole can be machined only part way through the top or bottom of the device.

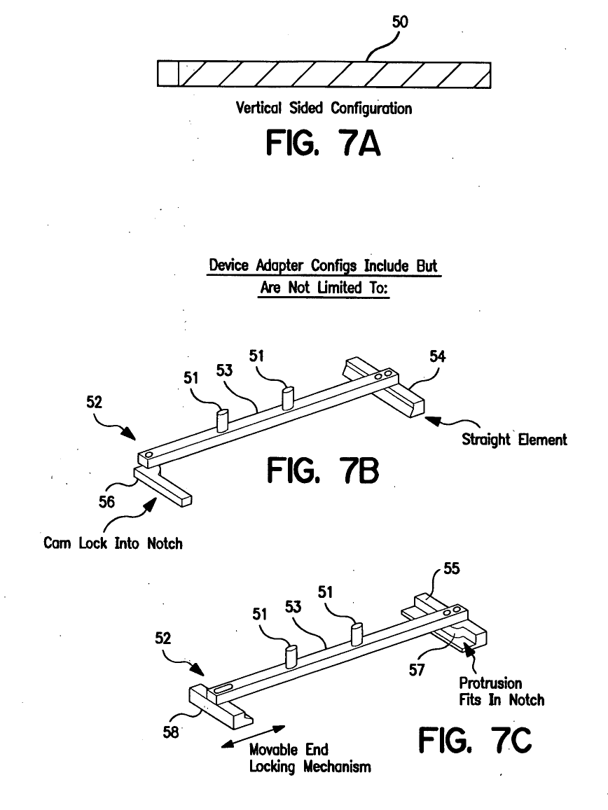

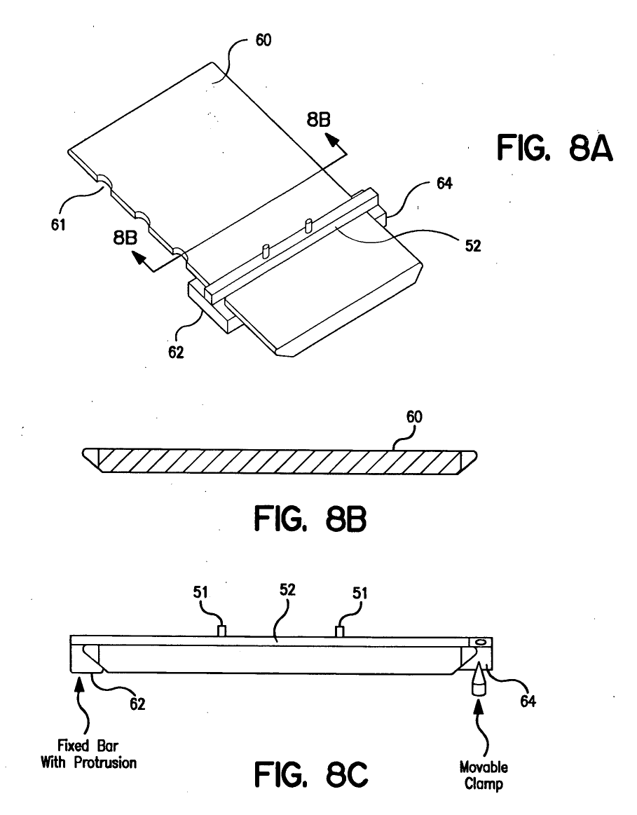

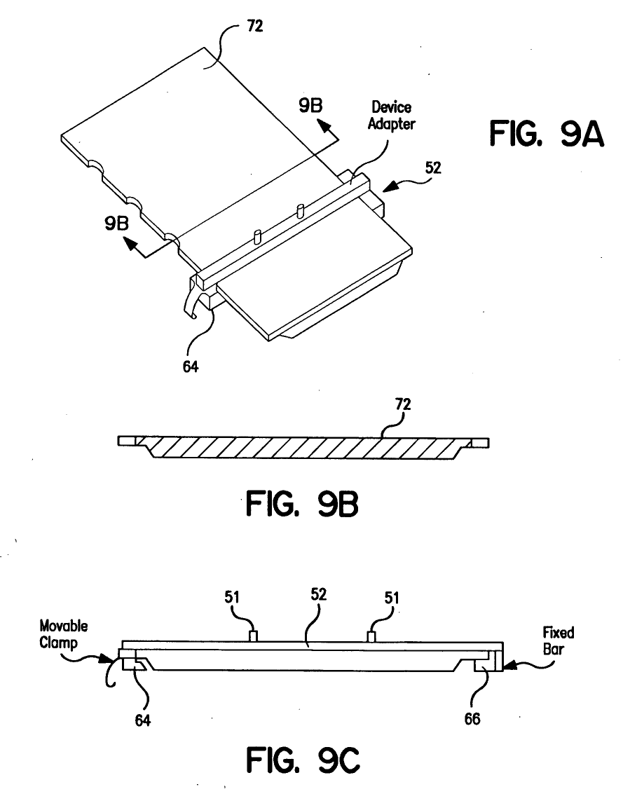

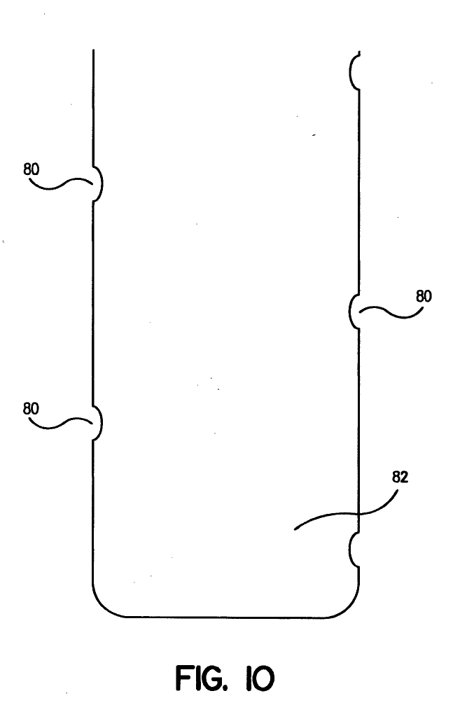

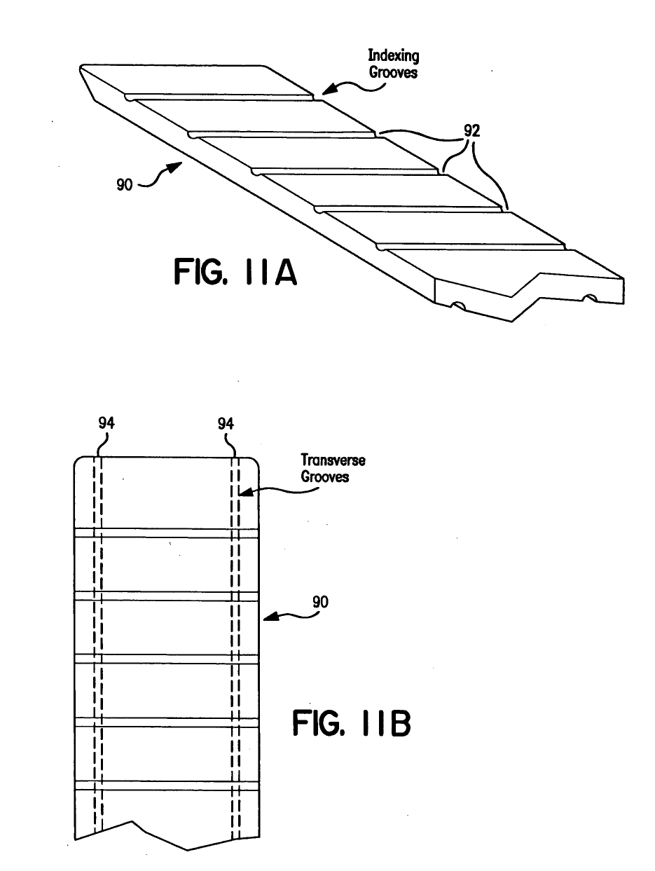

The present invention contemplates the direct attachment of various accessory devices to the patient support device as well as the use of an accessory device adaptor 52 that creates an interface between the device and an accessory device. FIGS. 7A-7C, 8A-8C and 9A-9C illustrate the use of a device adaptor with the present invention. FIGS. 7A-7C show the use of a device adaptor with a vertical sidewall patient support device configuration 50. In one embodiment, the device adaptor 52 has a cross bar 53 with a straight element 54 on one side and a moveable cam 56 on the second side for locking into an indexing notch. The straight element is in contact with the vertical side of the device thereby accurately and securely clamping the device adaptor 52. The cross bar 53 can have appropriately spaced pins 51 or any acceptable configuration for receiving various accessory devices. The accessory device can be removably secured or securely locked to the accessory device adaptor depending upon the artisan's specific requirements. FIG. 7C illustrates a variation of the device adaptor with a movable end locking mechanism 58 attached to the cross bar 53 and a straight element 55 with a protrusion 57 designed to fit securely into a notch on the patient support device.

FIGS. 8A-8C illustrate the use of the device adaptor 52 with a support device comprising chamfered edges. In this embodiment, the device adaptor 52 secures across the support device 60 by contacting the notch 61. FIG. 8B shows a cross section of the patient device 60 while FIG. 8C shows a cross section of the support device with device adaptor 52 in place. In this configuration, a movable clamp 64 secures one side of the device adaptor 52 while the second side includes a fixed bar with a protrusion 62 (protrusion not shown). The protrusion mateably fits into one of the notch cut into the support device 60.

FIGS. 9A-9C show the patient device of the present invention with the lip configuration. In this configuration, the top surface extends laterally beyond the sidewall thereby creating a lip. A device adaptor 52 can be secured to the support device 72 for receiving various accessory devices. FIG. 9B is a cross sectional view of the device 72 which illustrates the lip configuration. FIG. 9C shows the attachment of a device adaptor 52 by using a movable clamp 64 on one side of the adaptor and a fixed bar 66 on the second side.

The present invention contemplates the use of asymmetrically spaced indexing means. As shown in FIG. 10, this configuration results in a notch 80 on one side of the device 82 with the directly opposing side area free of a positioning feature. Asymmetrically spaced indexing notches 80 enables a more secure attachment of an accessory device adaptor or a more secure attachment of the accessory itself. A more secure attachment is achieved because it eliminates the need to cut precisely opposing notches and provides a true flat edge for clamping. Not only is the attachment more secure but the patient support device can be reversibly used, thereby increasing flexibility of the device and accommodating a wider range of treatment systems. For example, one end of the present device can be cantilevered over the edge of a couch top allowing 360 degree treatment range. If cantilevering is not desirable, the patient support device can be rotated 180 degrees yet still provide more accurate positioning because the asymmetrically spaced positioning features oppose a flat sidewall portion.

The use of indexing grooves can be incorporated into at least one surface of the support device. FIG. 11A illustrates a series of indexing grooves 92 across a surface of the device 90. These grooves can be spaced any appropriate distance at any desired depth. By incorporating the indexing means within the surface of the device, we have avoided the need for indexing notches in the sides or the sidewalls of the device. Not only does this create a precise Cartesian coordinate system on the device 90 but the indexing means can be more accurately spaced resulting in more accurate patient positioning. In addition to the indexing grooves, FIG. 11B shows the use of transverse grooves 94 lengthwise along the patient device 90. The transverse grooves 94 provide an additional attachment means which allows a more precise and secure attachment of an accessory device adaptor or accessory devices. Although the indexing grooves 92 and the transverse grooves 94 can by placed on the same surface, a preferred arrangement incorporates the indexing grooves 92 on the top surface of the device 90 and the transverse grooves 94 on the bottom surface. As one skilled in the art would readily recognize, the use of indexing grooves can be incorporated with the chamfered sidewalls, the extended lip configuration or with other embodiments of the present invention.

The present invention can be used in conjunction with most available couches as well as many available accessories. By way of example, and in no way intended to be limiting, one such accessory is a readily available deformable low temperature thermoplastic mask. One such product is a specialty mask currently sold by WFR/Aquaplast which can be attached to the present invention. The thermoplastic mesh mask is formed to fit the patient's features and dimensions and is either attached directly to the patient support device or to the accessory device adaptor in order to restrict the patient's movement and accurately and repeatably position the patient for treatment.

This description and the Figures shown illustrate a few examples of the present invention and are in no way meant to be limiting. Several different specific designs are contemplated by the inventors without parting from the original scope of the present invention and would be easily recognizable by those skilled in the art. Whereas the invention has been shown and described in connection with the preferred embodiments thereof, it will be understood that many modifications, substitutions and additions can be made which are within the intended broad scope of the following claims.

We claim:

1. A patient support device comprising a top surface, a bottom surface, two sides and at least two sidewalls; wherein the first side contains an integral indexing means and the second side is free of indexing means; and wherein the integral indexing means comprises at least one positioning feature.

2. A patient support device of claim 1 wherein the positioning feature is at least one selected from the group consisting of a notch, slat, indentation, cutout, scallop, groove, hole, protrusion, tab, pin and bar.

3. A patient support device of claim 1, wherein the top surface extends laterally beyond at least one sidewall, thereby forming a lip.

4. A patient support device of claim 1, wherein at least one sidewall is chamfered with respect to the top surface.

5. A patient support device of claim 1, wherein at least one sidewall is substantially perpendicular with respect to the top surface.

6. A patient support device of claim 1, further comprising at least one accessory device removably secured to at least one positioning feature.

7. A patient support system comprising;
a) a patient support device comprising a top surface, a bottom surface, two sides and at least two sidewalls,
b) an integral indexing means comprising at least one positioning feature on a first side,
c) a second side that is free of positioning features, and
d) at least one accessory device removably secured to at least one positioning feature.

8. A patient support system of claim 7, further comprising an accessory device adaptor, wherein the accessory device adaptor is mateably secured to the patient support device using at least one positioning feature on the first side and wherein the at least one accessory device is removably secured to the accessory device adaptor.

9. A patient support system of claim 8, wherein the accessory device adaptor provides an accurate and repeatable interface between the patient support device and the at least one accessory device.

10. A patient support system of claim 7, wherein the accessory device can be precisely, securely and repeatably attached and removed from the patient support device.

11. A patient support system of claim 7, for accurately and repeatably immobilizing a patient for diagnostic imaging or treatment.

12. A patient support system of claim 7, wherein the second side comprises at least one positioning feature, and wherein the at least one positioning feature on the first side is asymmetrically spaced from the at least one positioning feature on the second side.

13. A patient support surface of claim 12, wherein the positioning features on the sidewalls are independently selected from the group consisting of a notch, slat, indentation, cutout, scallop, groove, hole, protrusion, tab, pin and bar.

14. A patient support system of claim 8, wherein the accessory device adaptor has two opposing ends and further comprises;
a) an attachment feature on the first end of the adaptor for mateably joining the adaptor to the at least one positioning feature on the first side,
b) an element on the second end in contact with the second side of the patient support device, and
c) an attachment means for mateably joining and securing an accessory device to the accessory device adaptor.

15. A patient support system of claim 14, wherein the attachment feature is at least one selected from the group consisting of a clamp, cam lock, interference fit clip, pin, post and bar.

16. A patient support system of claim 15, wherein the attachment feature is incorporated into at least one positioning feature.

17. A patient support device comprising a top surface, a bottom surface, two sides, at least two sidewalls and an integral indexing means; wherein the integral indexing means comprises at least one positioning feature on the first side and at least one positioning feature on the second side and, wherein the at least one positioning feature on the first side is asymmetrically spaced from the at least one positioning feature on the second side.

18. A patient support device of claim 17, wherein the positioning feature on each of the sides is at least one independently selected from the group consisting of a notch, slat, indentation, cutout, scallop, groove, hole, protrusion, tab, pin and bar.

19. A patient support device of claim 17, wherein the top surface extends laterally beyond at least one sidewall, thereby forming a lip.

20. A patient support device of claim 17, wherein at least a portion of one sidewall is substantially perpendicular with respect to the top surface.

21. A patient support device of claim 17, wherein at least a portion of one sidewall of the patient support device is chamfered with respect to the top surface.

22. A patient support device of claim 17, further comprising at least one accessory device removably secured to at least one positioning feature.

23. A patient support system of claim 17; further comprising an accessory device adaptor, wherein the accessory device adaptor has two opposing ends and further comprises;
a) an attachment feature on the first end of the adaptor for mateably joining the adaptor to the at least one positioning feature on the first side,
b) an element on the second end in contact with the second side of the patient support device, and
c) an attachment means for mateably joining and securing an accessory device to the accessory device adaptor.

24. A patient support system of claim 23, wherein the attachment feature is at least one selected from the group consisting of a clamp, cam lock, interference fit clip, pin, post and bar.

25. A patient support device comprising a top surface, a bottom surface, two sides, at least two sidewalls, and an integral indexing means for accurate and repeatable patient positioning, wherein at least two sidewalls are chamfered.

26. A patient support device of claim 25, wherein the integral indexing means comprises at least one selected from the group consisting of a notch, slat, indentation, cutout, scallop, groove, hole, protrusion, tab, pin and bar.

27. A patient support device of claim 25, wherein the indexing means comprises at least one positioning feature on the first side and at least one positioning feature on the second side, wherein the at least one positioning feature on the first side is asymmetrically spaced from the at least one positioning feature on the second side.

28. A patient support device of 27, wherein the positioning features on the sides are independently selected from the group consisting of a notch, slat, indentation, cutout, scallop, groove, hole, protrusion, tab, pin and bar.

29. A patient support device of claim 25, wherein the top surface extends laterally beyond at least one sidewall, thereby forming a lip.

30. A patient support device of claim 29, wherein the integral indexing means is contained in the lip.

31. A patient support device of claim 26, wherein the integral indexing means is contained in the chamfered sidewalls.

32. A patient support device of claim 26, wherein the integral indexing means is contained in the chamfered sidewall but does not extend from the top surface to the bottom surface of the device.

33. A patient support device of claim 25, further comprising at least one accessory device removably secured to at least one positioning feature.

34. A patient support system of claim 25, further comprising an accessory device adaptor, wherein the accessory device adaptor has two opposing ends and further comprises;
a) an attachment feature on the first end of the adaptor for mateably joining the adaptor to the at least one positioning feature on the first side,
b) an element on the second end in contact with the second side of the patient support device, and
c) an attachment means for mateably joining and securing an accessory device to the accessory device adaptor.

35. A patient support system of claim 34, wherein the attachment feature is at least one selected from the group consisting of a clamp, cam lock, interference fit clip, pin, post and bar.

36. A patient support device comprising a top surface, a bottom surface, two sides, at least two sidewalls and an integral indexing means, wherein the integral indexing means is incorporated into at least one surface of the device and wherein, the integral indexing means is at least one indexing groove.

37. A patient support device of claim 36, wherein the at least one indexing groove reaches from the first side to the second side.

38. A patient support device of claim 37, wherein the integral indexing means are multiple indexing grooves and the indexing grooves are placed along the length of the patient support device at defined intervals.

39. A patient support device of claim 36, further comprising at least one transverse groove on at least one surface of the support device and the transverse groove runs lengthwise along the support device.

40. A patient support device of claim 39, wherein the at least one transverse groove is located on the opposite surface from the at least one indexing groove.

41. A patient support device of claim 36, wherein the top surface of the support device extends laterally beyond at least one sidewall, thereby forming a lip.

42. A patient support device of claim 36, wherein at least one sidewall of the support device is chamfered with respect to the top surface.

43. A patient support device of claim 36, further comprising at least one accessory device removably secured to at least one positioning feature.

44. A patient support system of claim 36, further comprising an accessory device adaptor, wherein the accessory device adaptor is mateably secured to the patient support device using at least one indexing groove on at least one surface and wherein the at least one accessory device is removably secured to the accessory device adaptor.

45. A patient support system of claim 44, wherein the accessory device adaptor has two opposing ends and a positioning feature and further comprises;
a) an attachment feature for positioning the adaptor to the at least one indexing groove,
b) an element on at least one end in contact with a sidewall of the patient support device, and
c) an attachment means for mateably joining and securing an accessory device to the accessory device adaptor.

46. A patient support system of claim 45, wherein the attachment feature is at least one selected from the group consisting of a clamp, cam lock, interference fit clip, pin, post and bar.
